(19) United States
(12) Patent Application Publication
(10) Pub. No.: US 2026/0025231 A1
(43) Pub. Date: Jan. 22, 2026

(54) BIT TO SYMBOL MAPPING DESIGN FOR BIT-LEVEL CONSTELLATION SHAPING

(71) Applicant: QUALCOMM Incorporated, San Diego, CA (US)

(72) Inventors: Liangming WU, Beijing (CN); Wei LIU, Beijing (CN); Kexin XIAO, Shanghai (CN); Changlong XU, Beijing (CN); Hao XU, Beijing (CN); Ori SHENTAL, Marlboro, NJ (US); Thomas Joseph RICHARDSON, South Orange, NJ (US)

(21) Appl. No.: 18/995,110

(22) PCT Filed: Sep. 2, 2022
(86) PCT No.: PCT/CN2022/116708

§ 371 Date: Jan. 15, 2025

(51) Int. Cl. H04L 1/00; H04L 27/04

(52) U.S. Cl. CPC H04L 1/0061; H04L 1/0042; H04L 1/0045; H04L 1/0058; H04L 27/04

(57) ABSTRACT

The apparatus may be configured to process input information including a set of information bits for a quadrature amplitude modulated (QAM) transmission by performing a bit-shaping operation for the set of information bits to generate a set of shaped bits and adding cyclic redundancy check (CRC) bits before forward error correction (FEC) on a combination of the set of information bits and the CRC bits. The apparatus may further be configured to transmit the QAM transmission. The apparatus may be configured to receive a QAM transmission; perform a FEC decoding on the QAM transmission; obtain CRC bits from the QAM transmission after the FEC decoding; and perform a bit level de-shaping operation on a set of shaped bits to obtain a set of information bits.

### TECHNICAL FIELD

The present disclosure relates generally to communication systems, and more particularly, to signal encoding based on a bit to symbol mapping.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to process input information including a set of information bits for a quadrature amplitude modulated (QAM) transmission by performing a bit-shaping operation for the set of information bits to generate a set of shaped bits and adding cyclic redundancy check (CRC) bits before forward error correction (FEC) on a combination of the set of information bits and the CRC bits. The apparatus may further be configured to transmit the QAM transmission.

In an aspect of the disclosure, a method, a computer-readable medium, and an apparatus are provided. The apparatus may be configured to receive a QAM transmission; perform a FEC decoding on the QAM transmission; obtain CRC bits from the QAM transmission after the FEC decoding; and perform a bit level de-shaping operation on a set of shaped bits to obtain a set of information bits.

In an aspect of the disclosure, a method, a computer-readable medium, and an apparatus are provided. The apparatus may be configured to perform a bit-shaping operation for a set of information bits to generate a set of shaped information bits; map the set of shaped information bits, non-shaped information bits, shaping bits, parity bits, and CRC bits to symbols with a bit-to-symbol mapping for block-code based shaping in an order based on one or more rules; and transmitting a QAM transmission.

In an aspect of the disclosure, a method, a computer-readable medium, and an apparatus are provided. The apparatus may be configured to receive an indication of a set of one or more rules for a bit-to-symbol mapping for block-code based shaping of a set of shaped information bits, non-shaped information bits, shaping bits, parity bits, and CRC bits to symbols; receive a QAM transmission; perform a decoding on the QAM transmission; and perform a bit level de-shaping operation on a set of shaped bits included in the QAM transmission to obtain a set of information bits based on the indication of the one or more rules.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a block diagram of a base station 310 in communication with a UE 350 in an access network.

FIG. 4 is a diagram illustrating a set of modules and/or components of an encoder including probabilistic shaping.

FIG. 5 is a diagram illustrating an encoding pipeline in accordance with some aspects of the disclosure.

FIG. 6 is a diagram 60 illustrating an encoding pipeline in accordance with some aspects of the disclosure.

FIG. 7 is a set of diagrams illustrating different potential bit mappings to a set of five symbols in accordance with some aspects of the disclosure.

FIG. 8 is a diagram illustrating a transmitting device and receiving device using a bit-level mapping in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an apparatus.

FIG. 14 is a diagram illustrating an example of a hardware implementation for a network entity.

### DETAILED DESCRIPTION

In some aspects of wireless communication an encoder and/or encoding pipeline may include probabilistic shaping. There is a relationship between bit-level and symbol transmit power, for example, a second bit (e.g., a most significant bit (MSB)) or a third bit (e.g., a least significant bit (LSB)) may be more determinative of a transmit power than a sign bit. For example, the power associated with a symbol “S” may be related to a square of an amplitude of the symbol such that switching a bit u0 from a “1” to a “0” may lower a transmit power (from '49 to ‘1’ or from ‘25’ to ‘9’) and switching a bit u1 from a “1” to a “0” may lower a transmit power (from '49 to ‘25’ or from ‘9’ to ‘1’).

In a shaping process, the probability of ‘u₀’ and/or ‘u₁’ taking a value of ‘0’ may be increased compared to probability of ‘u₀’ and/or ‘u₁’ taking a value of ‘1’ so that the average power is reduced. In some aspects of shaping encoders, a transmitter may ‘mask’ information bits and then jointly encode the shaped information bits and information for shaping. A corresponding decoder may jointly decode shaped information bits and the information for shaping and then reencode the bits to recover the original information bits. For some implementations, bit-level shaping is performed by mapping parity bits to high reliability bits (e.g., sign bits) while the shaped bits may be mapped to the remaining bit locations (e.g., MSBs and/or LSBs, excluding sign bits). In some aspects of the disclosure a mapping of shaped information bits, non-shaped information bits, shaping bits, parity, and/or CRC bits is provided to reduce an average transmission power.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an clement, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

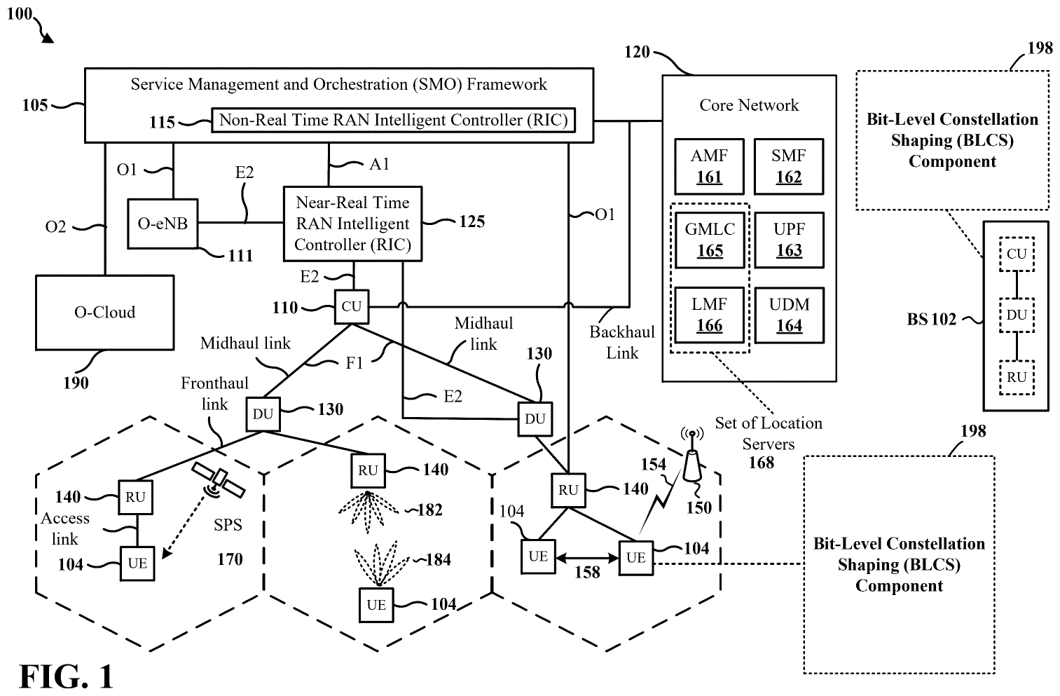

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FRI characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 or the base station 102 may include a bit-level constellation shaping (BLCS) component 198 that may be configured to process input information including a set of information bits for a QAM transmission by performing a bit-shaping operation for the set of information bits to generate a set of shaped bits and adding CRC bits before FEC on a combination of the set of information bits and the CRC bits; and transmit the QAM transmission. In certain aspects, the BLCS component 198 may be configured to receive a QAM transmission; perform a FEC decoding on the QAM transmission; obtain CRC bits from the QAM transmission after the FEC decoding; and perform a bit level de-shaping operation on a set of shaped bits to obtain a set of information bits. In certain aspects, the BLCS component 198 may be configured to perform a bit-shaping operation for a set of information bits to generate a set of shaped information bits; map the set of shaped information bits, non-shaped information bits, shaping bits, parity bits, and CRC bits to symbols with a bit-to-symbol mapping for block-code based shaping in an order based on one or more rules; and transmitting a QAM transmission. In certain aspects, the BLCS component 198 may be configured to receive an indication of a set of one or more rules for a bit-to-symbol mapping for block-code based shaping of a set of shaped information bits, non-shaped information bits, shaping bits, parity bits, and CRC bits to symbols; receive a QAM transmission; perform a decoding on the QAM transmission; and perform a bit level de-shaping operation on a set of shaped bits included in the QAM transmission to obtain a set of information bits based on the indication of the one or more rules. Although the following description may be focused on 5G NR, the concepts described herein may be applicable to other similar areas, such as LTE, LTE-A, CDMA, GSM, and other wireless technologies.

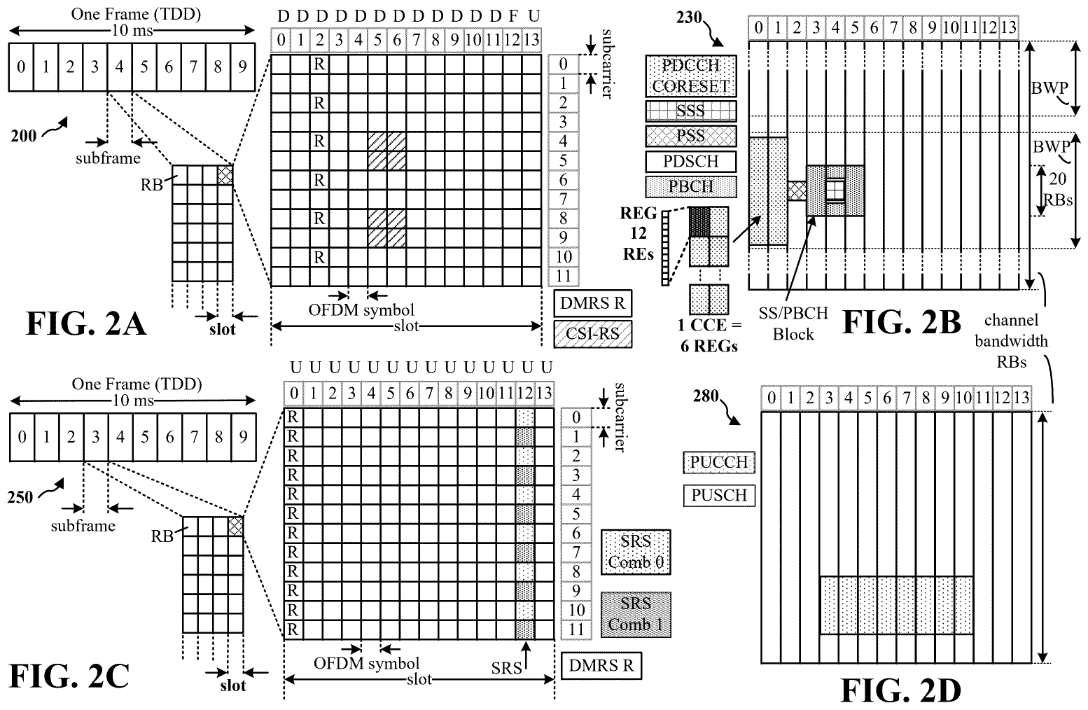

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

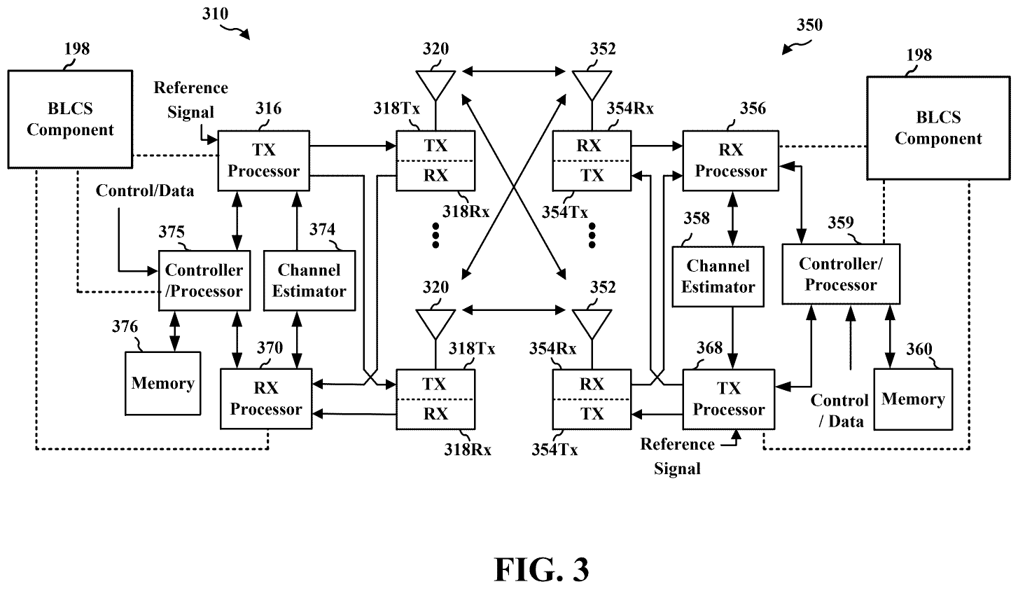

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, FEC coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission. At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the BLCS component 198 of FIG. 1.

At least one of the TX processor 316, the RX processor 370, and the controller/processor 375 may be configured to perform aspects in connection with the BLCS component 198 of FIG. 1.

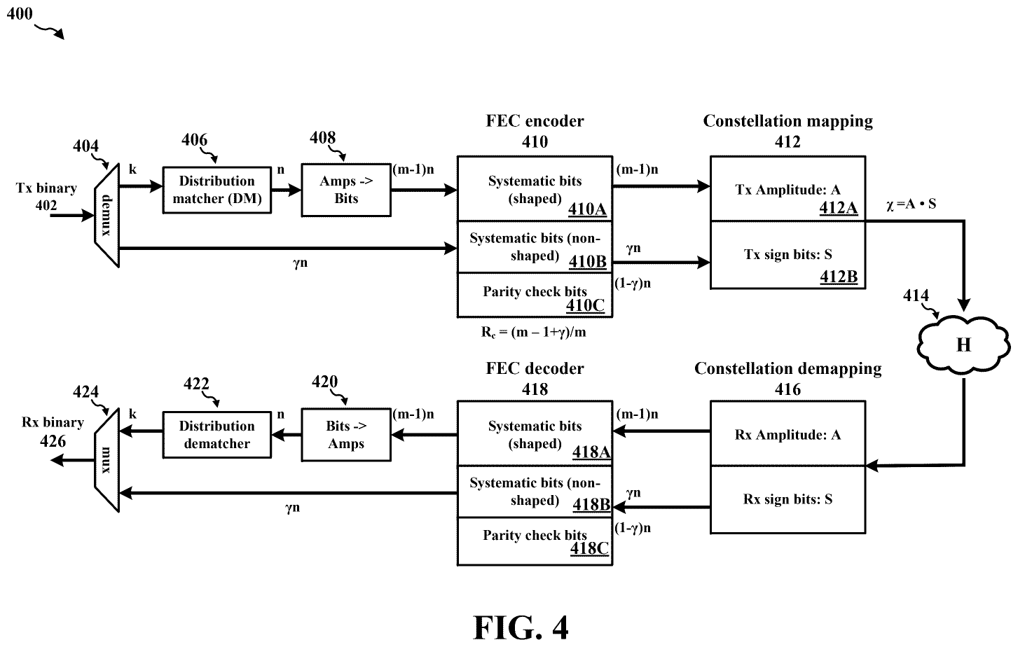

In some aspects of wireless communication an encoder and/or encoding pipeline may include probabilistic shaping. FIG. 4 is a diagram 400 illustrating a set of modules and/or components of an encoder including probabilistic shaping. The encoding pipeline may begin with a set of transmission (Tx) bits 402. The Tx bits 402 may be processed by a demultiplexer 404 into a set of k bits, where k is a uniform input bit length to a distribution matcher (DM) 406. The distribution matcher may perform a probabilistic shaping operation that produces a set of n bits where n is greater than k (e.g., a shaping rate Rₛ defined as k/n). The larger number of bits may be used to enable a unique mapping of a set of input bits to a set of output bits (or symbols) that have a particular distribution of bits (or bit groups that map to symbols). The set of output bits may be mapped to amplitudes (or symbols representing a set of m bits) by a component 408. For example, m may correspond to a log-2 of 2^{m} ASK size, e.g., a number of bits per 1 dimension, and n may correspond to a shaped output of a 1 dimension ASK sequence length. An FEC encoder 410 may combine a set of shaped bits 410A, a set of non-shaped bits 410B, and a set of parity (check) bits 410C to produce stets of bits used by constellation mapping 412 to determine a set of amplitudes (A) 412A and signs(S) 412B for a transmitted signal (e.g., x=A*S). The transmitted signal may be transmitted via a channel 414 characterized by a matrix H and be received at a decoding device. The decoding pipeline at the decoding device may mirror the functions of the encoding pipeline. For example, the constellation demapping component 416 may identify a set of amplitudes and signs and generate a set of shaped bits 418A, a set of non-shaped bits 418B, and a set of parity (check) bits 418C at a FEC encoder 418. The shaped bits may then be processed at a component 420 to produce a set of n bits from a set of (m−1)*n shaped bits. The n bits may then be processed by a distribution de-matcher 422 that maps the n bits to a set of k bits. The set of k bits and a set of γn bits associated with the non-shaped bits 418B may then be processed at multiplexer 424 to produce a set of Rx bits 426, where γ corresponds to a rate of extra (e.g., uniform) data bits carried over the symbol signs. An FEC rate R_{c} may correspond to R_{c}=(m−1+γ)/m≥(m−1)/m. The transmission rate Rₜ may be represented as Rₜ=R_{S}+γ<H(A)+γ.

There is a relationship between bit-level and symbol transmit power, for example, a second bit (e.g., a MSB, bit “u₀” in Table 2 below) or a third bit (e.g., a LSB, bit “u₁” in the table below) may be more determinative of a transmit power than a sign bit. For example, the power associated with a symbol “S” may be related to a square of an amplitude of the symbol such that switching a bit u₀ from a “1” to a “0” may lower a transmit power (from '49 to ‘1’ or from ‘25’ to ‘9’) and switching a bit u1 from a “1” to a “0” may lower a transmit power (from '49 to ‘25’ or from ‘9’ to ‘1’).

TABLE 2
Bit to symbol mapping for 8-ASK

| | | | | | | | | |
|---|---|---|---|---|---|---|---|---|
| S | −7 | −5 | −3 | −1 | 1 | 3 | 5 | 7 |
| Sign | 0 | 0 | 0 | 0 | 1 | 1 | 1 | 1 |
| u₀ | 1 | 1 | 0 | 0 | 0 | 0 | 1 | 1 |
| u₁ | 0 | 1 | 1 | 0 | 0 | 1 | 1 | 0 |

In a shaping process, the probability of ‘u₀’ and/or ‘u₁’ taking a value of ‘0’ may be increased compared to probability of ‘u₀’ and/or ‘u₁’ taking a value of ‘1’ so that the average power is reduced. In some aspects of shaping encoders, a transmitter may ‘mask’ information bits and then jointly encode the shaped information bits and information for shaping. A corresponding decoder may jointly decode shaped information bits and the information for shaping and then reencode the bits to recover the original information bits. For some implementations, bit-level shaping is performed by mapping parity bits to high reliability bits (e.g., sign bits) while the shaped bits may be mapped to the remaining bit locations (e.g., MSBs and/or LSBs, excluding sign bits). In some aspects of the disclosure a mapping of shaped information bits, non-shaped information bits, shaping bits, parity, and/or CRC bits is provided to reduce an average transmission power.*

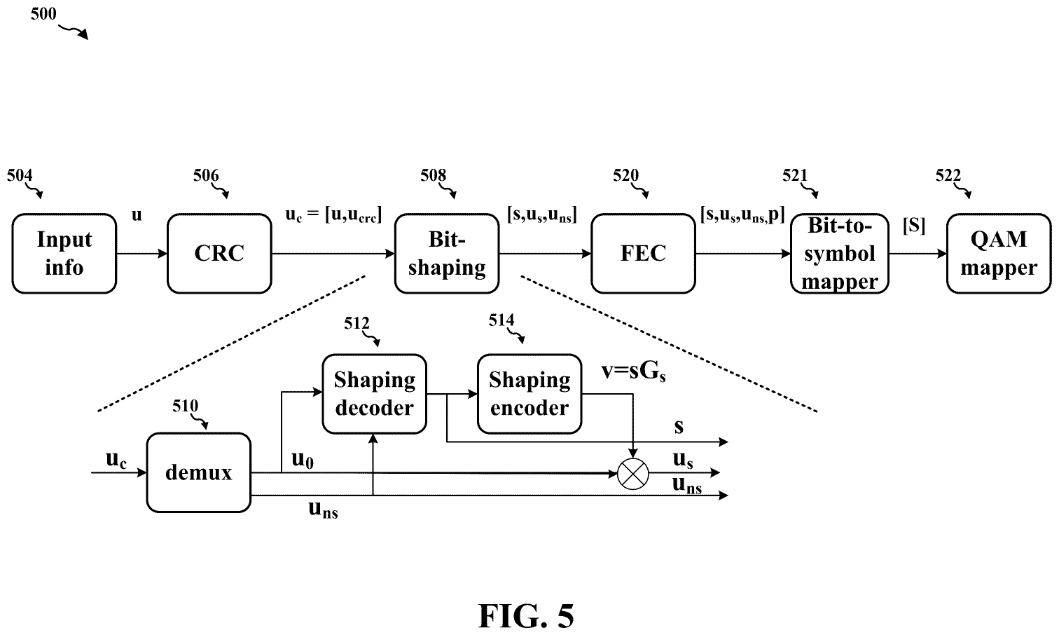

FIG. 5 is a diagram 500 illustrating an encoding pipeline in accordance with some aspects of the disclosure. The encoding pipeline illustrated in diagram 500 may include input info 504 (u), a CRC component 506 that, in some aspects, may add CRC bits to the information bits. After adding the CRC bits, the encoding pipeline may include a bit-shaping component 508. The bit-shaping component 508 may include a demultiplexer 510 that may break down the input to the bit shaping component 508 into a first set of bits u₀ for shaping and a second set of bits uₙₛ for inclusion without additional shaping.

The encoding pipeline illustrated in diagram 700 may shape a first set of information bits (including the CRC bits) at shaping decoder 512 and shaping encoder 514 based on a configured probability distribution of ‘0s’ and ‘1s’ to reduce average transmission power. The bit shaping may be based on a known or configured mapping of shaped information bits (uₛ), unshaped information bits (uₙₛ), shaping bits (providing information about the shaping performed on the shaped information bits), and parity bits for block-code-based shaping. The parity bits may be generated by the FEC component 520. The mapping of the shaping bits, the parity bits, the shaped information bits, and the unshaped information bits may be implemented, in some aspects, by a bit-to-symbol mapper 521.

For example, the known or configured mapping implemented by the bit-to-symbol mapper 521 may include a first mapping that maps a first set of unshaped information bits to a set of sign bits; a second set of shaped information bits to a set of MSBs (e.g., corresponding to u₀ bits of Table 2); a third set of unshaped information bits to a set of remaining LSBs (e.g., corresponding to u₁ bits of Table 2); and a set of shaping bits and parity bits to LSBs remaining after mapping the information bits. The known or configured mapping, in some aspects, may include a second mapping that maps a first set of shaping and parity bits to the set of sign bits, a second set of shaped information bits to a set of MSBs (e.g., corresponding to u₀ bits of Table 2); a third set of unshaped information bits to a first set of LSBs (e.g., corresponding to u₁ bits of Table 2); and a fourth set of parity bits not included in the first set of shaping and parity bits (e.g., because there are more shaping and parity bits than sign bits) to LSBs remaining after mapping the information bits. In some aspects, the encoding pipeline may select one of the first or second mapping based on an MCS of the transmission, an FEC coding rate, or a shaping rate. The mapping may produce a set of one-dimensional symbols (e.g., a set of values for ‘S’ on a linear axis).

The output of the bit-to-symbol mapper 521 may then be processed by a quadrature amplitude modulation (QAM) mapping that maps the linear value to an amplitude and phase for a QAM signal at a QAM mapping component 522. The QAM mapped signal may than be transmitted and a receiving device may perform a reverse operation to decode the transmitted signal. For example, the decoding device may receive an indication of a set of one or more rules for a bit-to-symbol mapping for block-code based shaping of a set of shaped information bits, non-shaped information bits, shaping bits, parity bits, and CRC bits to symbols; perform a decoding on the QAM transmission; and perform a bit level de-shaping operation on a set of shaped bits included in the QAM transmission to obtain a set of information bits based on the indication of the one or more rules.

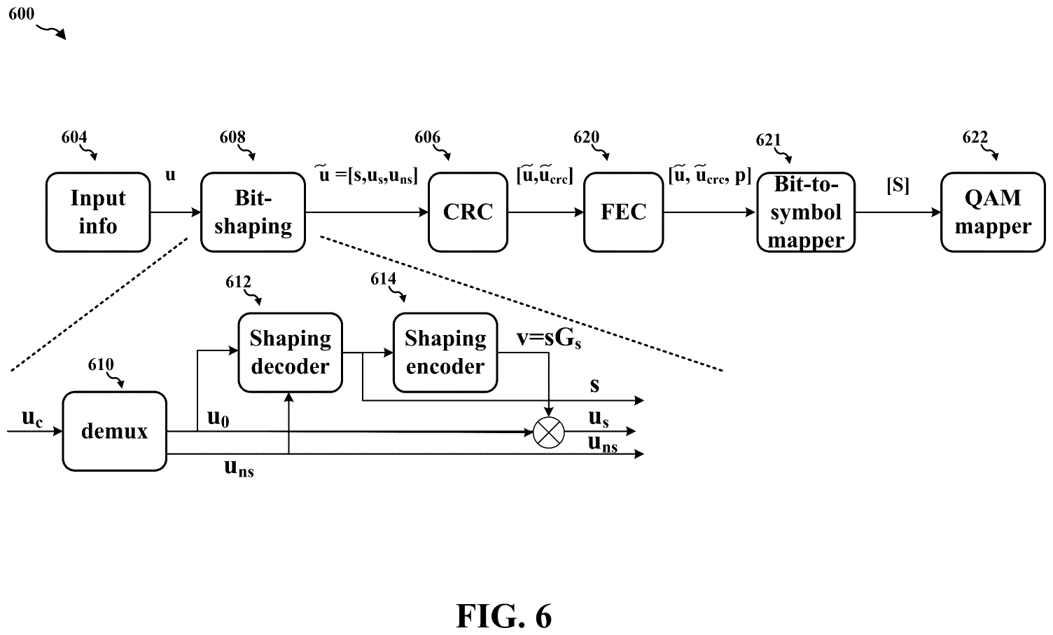

FIG. 6 is a diagram 600 illustrating an encoding pipeline in accordance with some aspects of the disclosure. The encoding pipeline illustrated in diagram 600 may include input info 604 (u) and a bit-shaping component 608. The bit-shaping component 608 may include a demultiplexer 610 that may break down the input to the bit shaping component 608 into a first set of bits u₀ for shaping and a second set of bits uₙₛ for inclusion without additional shaping.

The encoding pipeline illustrated in diagram 600 may shape a first set of information bits at shaping decoder 612 and shaping encoder 614 based on a configured probability distribution of ‘0s’ and ‘1s’ to reduce average transmission power. The bit shaping may be based on a known or configured mapping of shaped information bits (uₛ), unshaped information bits (uₙₛ), shaping bits (providing information about the shaping performed on the shaped information bits), and parity bits for block-code-based shaping. After the shaping, the encoding pipeline may include a CRC component 606 that, in some aspects, may add CRC bits to the shaped bits. The parity bits may be generated by the FEC component 620. The mapping of the shaping bits, the parity bits, the CRC bits, the shaped information bits, and the unshaped information bits may be implemented, in some aspects, by the bit-to-symbol mapper component 621.

For example, the known or configured mapping implemented by the bit-to-symbol mapper 621 may include a first mapping that maps a first set of unshaped information bits to a set of sign bits; a second set of shaped information bits to a set of MSBs (e.g., corresponding to u₀ bits of Table 2); a third set of unshaped information bits to a set of remaining LSBs (e.g., corresponding to u₁ bits of Table 2); and a set of shaping bits, CRC bits, and parity bits to LSBs remaining after mapping the information bits. The shaping bits, CRC bits, and parity bits, may be mapped to the LSBs in that order or in another order. The known or configured mapping, in some aspects, may include a second mapping that maps a first set of shaping and CRC bits to the set of sign bits, a second set of unshaped information bits to a set of bits remaining in the sign bits, a third set of shaped information bits to MSBs (e.g., corresponding to u₀ bits of Table 2); a fourth set of unshaped information bits to a first set of LSBs (e.g., corresponding to u₁ bits of Table 2); and a fifth set of parity bits to LSBs remaining after mapping the information bits. In some aspects, the encoding pipeline may select one of the first or second mapping based on an MCS of the transmission, an FEC coding rate, or a shaping rate. The mapping may produce a set of one-dimensional symbols (e.g., a set of values for ‘S’ on a linear axis).

The output of the bit-to-symbol mapper 621 may then be processed by a QAM mapping that maps the linear value to an amplitude and phase for a QAM signal at a QAM mapping component 622. The QAM mapped signal may than be transmitted and a receiving device may perform a reverse operation to decode the transmitted signal. For example, the decoding device may receive an indication of a set of one or more rules for a bit-to-symbol mapping for block-code based shaping of a set of shaped information bits, non-shaped information bits, shaping bits, parity bits, and CRC bits to symbols; perform a decoding on the QAM transmission; and perform a bit level de-shaping operation on a set of shaped bits included in the QAM transmission to obtain a set of information bits based on the indication of the one or more rules.

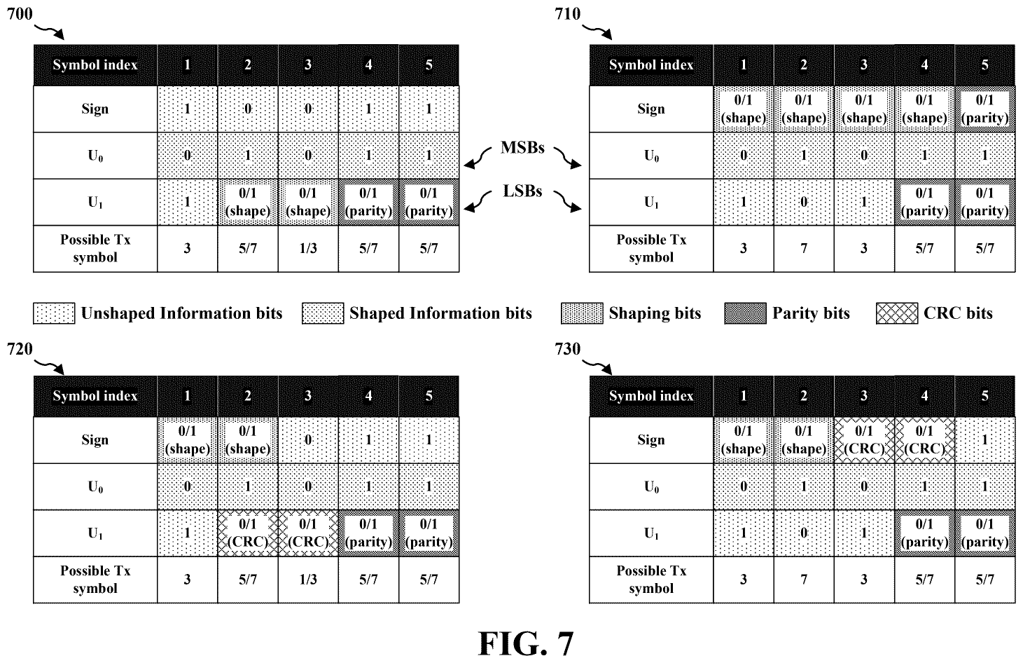

FIG. 7 is a set of diagrams (e.g., diagram 700, diagram 710, diagram 720, and diagram 730) illustrating different potential bit mappings to a set of five symbols in accordance with some aspects of the disclosure. For example, diagram 700 illustrates that a first mapping may map a first set of non-shaped information bits to a set of sign bits, a second set of shaped information bits to a set of MSBs, a third set of non-shaped information bits to a set of LSBs, a fourth set of shaping bits to a next set of LSBs, and a fifth set of parity (or CRC) bits to a last set of LSBs. Diagram 710 illustrates a second mapping that may map a first set of shaping bits to a set of sign bits, a second set of first parity bits to a remaining set of sign bits, a third set of shaped information bits to a set of MSBs, a fourth set of non-shaped information bits to a set of LSBs, and a fifth set of parity (or CRC) bits to a last set of LSBs.

Diagram 720 illustrates a third mapping that may map a first set of shaping bits to a set of sign bits, a second set of non-shaped information bits to a remaining set of sign bits, a third set of shaped information bits to a set of MSBs, a fourth set of non-shaped information bits to a set of LSBs, a fifth set of CRC bits to a next set of LSBs, and a sixth set of parity bits to a last set of LSBs. Diagram 730 illustrates a fourth mapping that may map a first set of shaping bits to a set of sign bits, a second set of CRC bits to a next set of sign bits, a third set of non-shaped information bits to a remaining set of sign bits, a fourth set of shaped information bits to a set of MSBs, a fifth set of non-shaped information bits to a set of LSBs, and a sixth set of CRC bits to a last set of LSBs. Additional configurations using MSBs for shaped information bits and other bits (e.g., sign bits and/or LSBs) for non-shaped information bits, shaping bits, parity bits, and/or CRC bits.

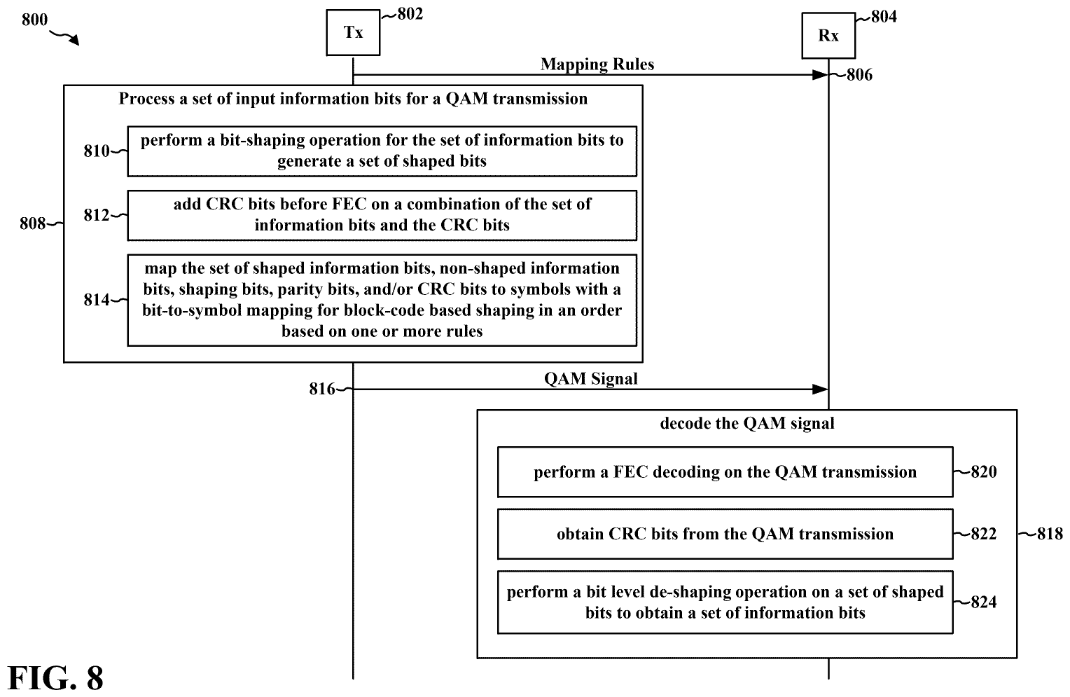

FIG. 8 is a diagram 800 illustrating a transmitting (Tx) device 802 and receiving (Rx) device 804 using a bit-level mapping in accordance with some aspects of the disclosure. The Tx device 802 may transmit, and the RX device 804 may receive, a set of mapping rules 806 for decoding a QAM signal and/or transmission. In some aspects, the Rx device 804 (and the Tx device 802) may receive the mapping rules from a third network node (not illustrated). In some aspects, the Tx device 802 may receive, and Rx device 804 may transmit, the mapping rules 806. The mapping rules may indicate one or more of the mappings discussed above in relation to FIG. 7. In some aspects, the mapping rules may include a correspondence between each particular mapping and a set of characteristics of a communication or encoding (e.g., a MCS, a FEC coding rate, or a shaping rate.

At 808, the Tx device 802 may process a set of bits for a QAM transmission. Processing the set of input bits, in some aspects, may include performing, at 810, a bit-shaping operation for a set of input information bits to generate a set of shaped information bits, a set of non-shaped information bits, a set of shaping bits, and a set of parity and/or CRC bits. Processing the set of input bits at 808, may include, in some aspects, adding CRC bits before processing by an FEC component (e.g., an FEC component 520 or 620), where the CRC bits may be added before or after the bit-shaping operation at 810 as described above in relation to FIGS. 5 and 6 above. In some aspects, the Tx device may omit adding CRC bits at 812.

The Tx device may then map the set of shaped bits, non-shaped bits, shaping bits, parity bits, and or CRC bits based on the mapping rules 806. The mapping may be according to any of the mappings discussed above in relation to FIG. 7 or any other mapping of shaped bits to a set of MSBs. Based on the mapping, the Tx device 802 may transmit, and the Rx device 804 may receive, QAM signal 816.

At 818, the Rx device 804 may begin processing the QAM signal 816. Processing the QAM signal 816 may include performing, at 820, a FEC decoding on the QAM signal 816. After the FEC, the Rx device 804 may obtain, at 822, a set of CRC bits (if CRC is used in the encoding). The Rx device may also perform, at 824, a bit-level de-shaping operation on a set of shaped bits according to the mapping rules to obtain a set of information bits (e.g., the input set of information bits processed by the encoding Tx device 802. In some aspects, obtaining the CRC bits at 822 may precede the bit-level de-shaping operation at 824 (e.g., if the CRC bits are added after the bit-level shaping operation by the encoding Tx device 802). In some aspects, obtaining the CRC bits at 822 may be performed after the bit-level de-shaping operation at 824 (e.g., if CRC bits are added before the bit-level shaping operation by the encoding Tx device 802).

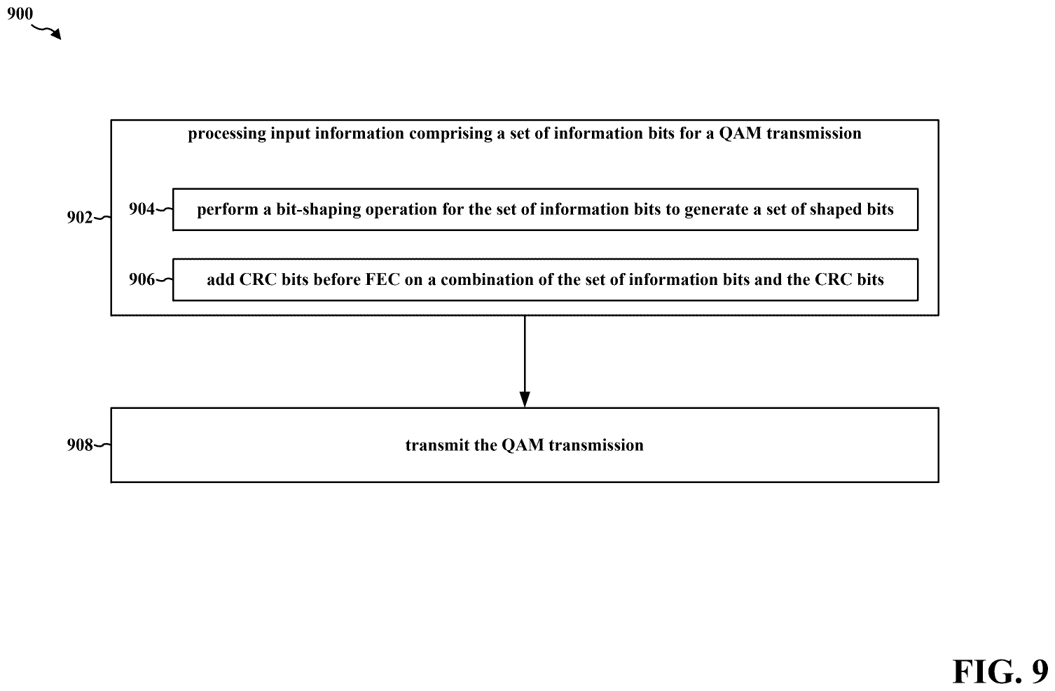

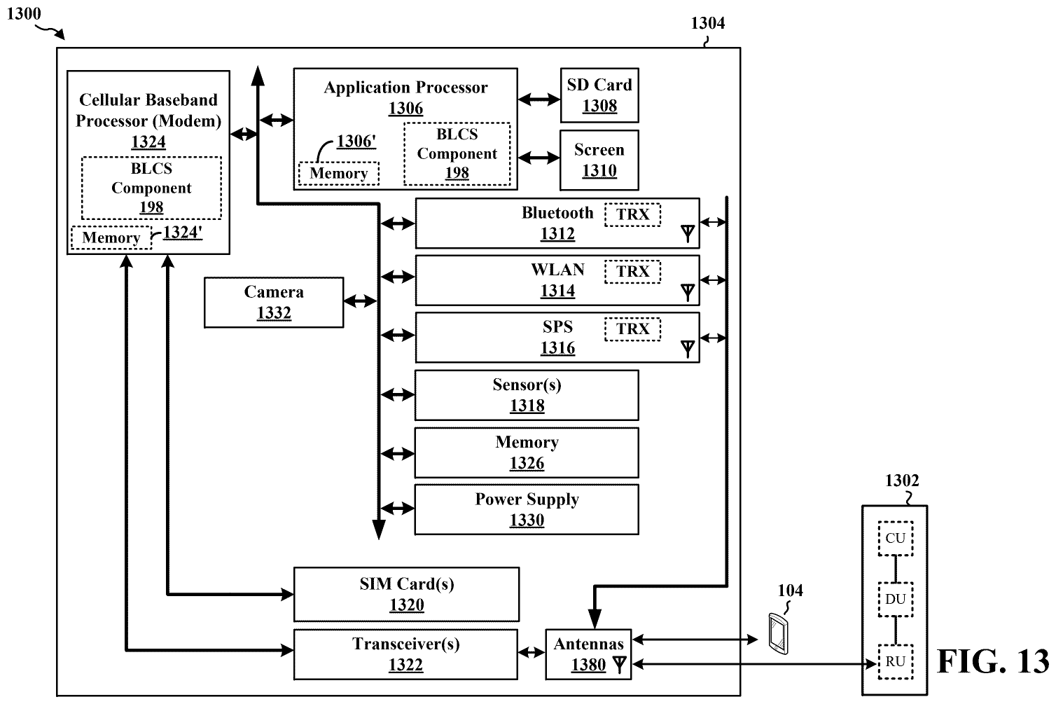

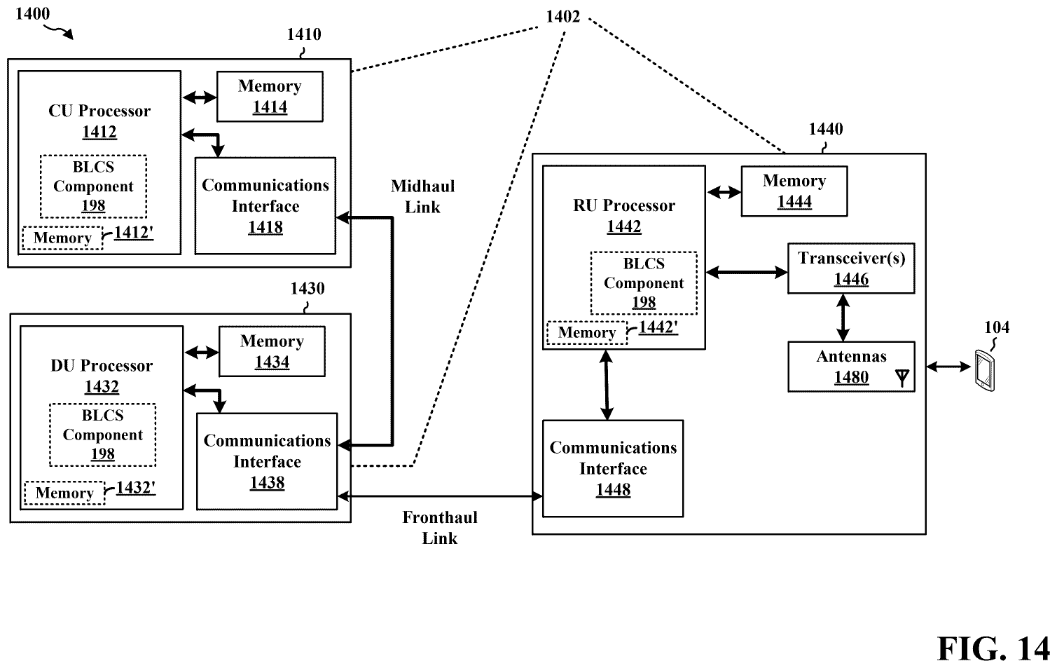

FIG. 9 is a flowchart 900 of a method of wireless communication. The method may be performed by a transmitting device such as a UE (e.g., the UE 104; the Tx device 802; the apparatus 1304) or a network node (e.g., the base station 102; the Tx device 802; the network entity 1402). At 902, the Tx device may process input information including a set of information bits for a QAM (or other amplitude modulated) transmission. Processing the input at 902, in some aspects, may include performing, at 904 a bit-shaping operation for the set of information bits to generate a set of shaped bits. In some aspects, processing the input at 902, may include adding, at 906, CRC bits before FEC on a combination of the set of information bits and the CRC bits. For example, 902-906 may be performed by application processor 1306, cellular baseband processor 1324, CU processor 1412, DU processor 1432, RU processor 1442, and/or BLCS component 198 of FIGS. 13 and 14. Adding the CRC bits, at 906, in some aspects may be performed before the bit-shaping operation at 904. For example, referring to FIGS. 5-8, a Tx device 802 implementing encoding pipeline illustrated in diagram 500 or 600, may process, at 808, a set of input information bits for a QAM transmission according to a mapping, such as one of mappings 700-730.

The mapping may be one of a first mapping that maps a first set of non-shaped information bits to a set of sign bits, a second set of shaped information bits to a set of MSBs, a third set of non-shaped information bits to a set of LSBs, a fourth set of shaping bits to a next set of LSBs, and a fifth set of parity (or CRC) bits to a last set of LSBs. The mapping, in some aspects, may be a second mapping that may map a first set of shaping bits to a set of sign bits, a second set of first parity bits to a remaining set of sign bits, a third set of shaped information bits to a set of MSBs, a fourth set of non-shaped information bits to a set of LSBs, and a fifth set of parity (or CRC) bits to a last set of LSBs.

The mapping, in some aspects, may be a third mapping that may map a first set of shaping bits to a set of sign bits, a second set of non-shaped information bits to a remaining set of sign bits, a third set of shaped information bits to a set of MSBs, a fourth set of non-shaped information bits to a set of LSBs, a fifth set of CRC bits to a next set of LSBs, and a sixth set of parity bits to a last set of LSBs. The mapping, in some aspects, may be a fourth mapping that may map a first set of shaping bits to a set of sign bits, a second set of CRC bits to a next set of sign bits, a third set of non-shaped information bits to a remaining set of sign bits, a fourth set of shaped information bits to a set of MSBs, a fifth set of non-shaped information bits to a set of LSBs, and a sixth set of CRC bits to a last set of LSBs. Additional configurations using MSBs for shaped information bits and other bits (e.g., sign bits and/or LSBs) for non-shaped information bits, shaping bits, parity bits, and/or CRC bits.

At 908, the Tx device may transmit the QAM transmission. For example, 908 may be performed by application processor 1306, cellular baseband processor 1324, transceiver(s) 1322, antenna(s) 1380, CU processor 1412, DU processor 1432, RU processor 1442, transceiver(s) 1446, antenna(s) 1480, and/or BLCS component 198 of FIGS. 13 and 14. For example, referring to FIG. 8, the Tx device 802 may transmit QAM signal 816.

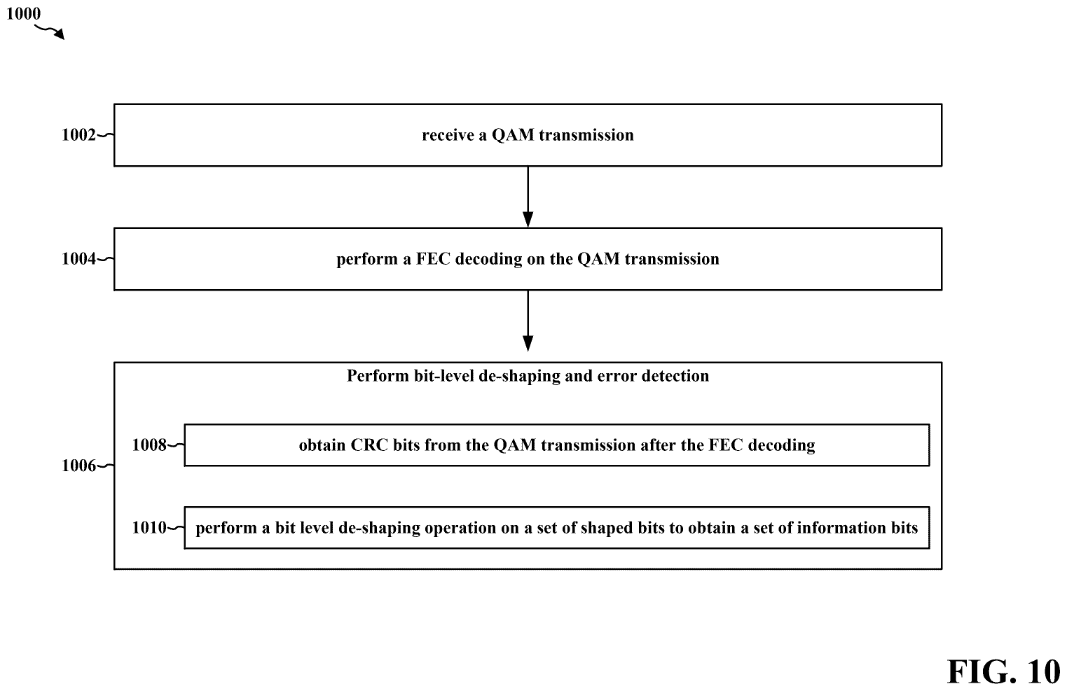

FIG. 10 is a flowchart 1000 of a method of wireless communication. The method may be performed by a receiving device such as a UE (e.g., the UE 104; the Rx device 804; the apparatus 1304) or a network node (e.g., the base station 102; the Rx device 804; the network entity 1402). At 1002, the Rx device may receive a QAM (or other amplitude modulated) transmission. For example, 1002 may be performed by application processor 1306, cellular baseband processor 1324, transceiver(s) 1322, antenna(s) 1380, CU processor 1412, DU processor 1432, RU processor 1442, transceiver(s) 1446, antenna(s) 1480, and/or BLCS component 198 of FIGS. 13 and 14. Referring to FIG. 8, for example, the Rx device 804 may receive QAM signal 816.

At 1004, the Rx device may perform a FEC decoding of the QAM transmission. For example, 1004 may be performed by application processor 1306, cellular baseband processor 1324, CU processor 1412, DU processor 1432, RU processor 1442, and/or BLCS component 198 of FIGS. 13 and 14. The FEC decoding may reproduce a set of soft bits associated with a set of shaped bits, shaping bits, and non-shaped bits. For example, referring to FIGS. 5-8, the Rx device 804 may perform FEC decoding at 820 a set of shaped information bits, non-shaped information bits, shaping bits, parity bits, and/or CRC bits from the QAM signal 816 according to a mapping of any of diagram 700-730.

At 1006, the Rx device may perform a bit-level de-shaping and error detection. The bit-level de-shaping and error detection may include obtaining, at 1008, CRC bits from the QAM transmission after the FEC decoding and performing, at 1010, a bit level de-shaping operation on a set of shaped bits to obtain a set of information bits. For example, 1006-1010 may be performed by application processor 1306, cellular baseband processor 1324, CU processor 1412, DU processor 1432, RU processor 1442, and/or BLCS component 198 of FIGS. 13 and 14. The CRC bits may be obtained at 1008 before or after the bit level de-shaping at 1010 based on whether the CRC was added to the information bits before or after a shaping operation. In some aspects, a CRC may be added after a bit-shaping operation in order to allow the RX device to perform an error detection operation immediately after the FEC decoding instead of after a bit level de-shaping to recover the CRC bits to be used for the error detection operation. However, adding the CRC after a bit-shaping operation may lead to CRC bits being placed at bits with higher reliability thus degrading performance compared to adding the CRC bits before the bit level shaping operation. For example, referring to FIGS. 5-8, the RX device 804 may obtain the CRC bits at 822 and perform a bit-level de-shaping operation at 824 based on one of the encoding pipelines illustrated in diagrams 500 or 600 and one of the mappings 700-730.

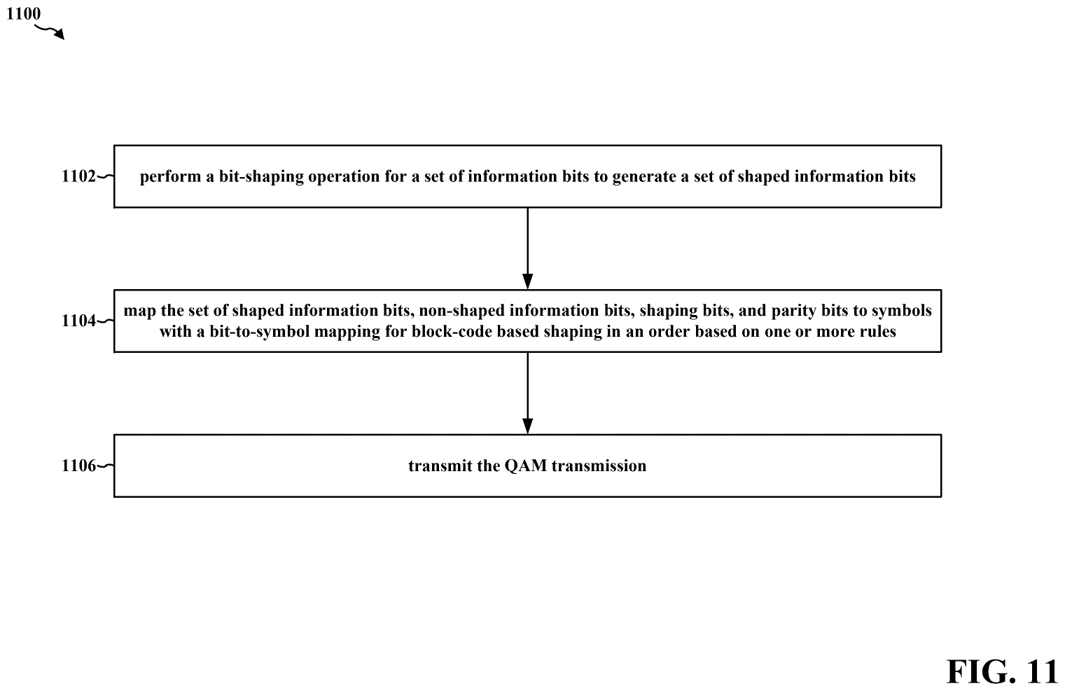

FIG. 11 is a flowchart 1100 of a method of wireless communication. The method may be performed by a transmitting device such as a UE (e.g., the UE 104; the Tx device 802; the apparatus 1304) or a network node (e.g., the base station 102; the Tx device 802; the network entity 1402). At 1102, the Tx device may perform a bit-shaping operation for a set of information bits to generate a set of shaped information bits. For example, 1102 may be performed by application processor 1306, cellular baseband processor 1324, CU processor 1412, DU processor 1432, RU processor 1442, and/or BLCS component 198 of FIGS. 13 and 14. For example, referring to FIGS. 5-8, a Tx device 802 implementing encoding pipeline illustrated in diagram 500 or 600, may perform, at 810, a bit-shaping operation for a set of information bits to generate a set of shaped information bits, a set of non-shaped information bits, shaping bits, parity bits.

At 1104, the Tx device may map the set of shaped information bits, non-shaped information bits, shaping bits, and parity bits to symbols based on a bit-to-symbol mapping for block-code based shaping in an order based on one or more rules. For example, 1104 may be performed by application processor 1306, cellular baseband processor 1324, CU processor 1412, DU processor 1432, RU processor 1442, and/or BLCS component 198 of FIGS. 13 and 14. The mapping may be one of a first mapping that maps a first set of non-shaped information bits to a set of sign bits, a second set of shaped information bits to a set of MSBs, a third set of non-shaped information bits to a set of LSBs, a fourth set of shaping bits to a next set of LSBs, and a fifth set of parity (or CRC) bits to a last set of LSBs. The mapping, in some aspects, may be a second mapping that may map a first set of shaping bits to a set of sign bits, a second set of first parity bits to a remaining set of sign bits, a third set of shaped information bits to a set of MSBs, a fourth set of non-shaped information bits to a set of LSBs, and a fifth set of parity (or CRC) bits to a last set of LSBs.

The mapping, in some aspects, may be a third mapping that may map a first set of shaping bits to a set of sign bits, a second set of non-shaped information bits to a remaining set of sign bits, a third set of shaped information bits to a set of MSBs, a fourth set of non-shaped information bits to a set of LSBs, a fifth set of CRC bits to a next set of LSBs, and a sixth set of parity bits to a last set of LSBs. The mapping, in some aspects, may be a fourth mapping that may map a first set of shaping bits to a set of sign bits, a second set of CRC bits to a next set of sign bits, a third set of non-shaped information bits to a remaining set of sign bits, a fourth set of shaped information bits to a set of MSBs, a fifth set of non-shaped information bits to a set of LSBs, and a sixth set of CRC bits to a last set of LSBs. Additional configurations using MSBs for shaped information bits and other bits (e.g., sign bits and/or LSBs) for non-shaped information bits, shaping bits, parity bits, and/or CRC bits. For example, referring to FIGS. 5, 6, and 8, the Tx device 802 may map, at 814, the set of shaped information bits, non-shaped information bits, shaping bits, and parity bits to symbols based on a bit-to-symbol mapping for block-code based shaping in an order based on one or more rules using one of bit-to-symbol mappers 521 and/or 621.

At 1106, the Tx device may transmit the QAM transmission. For example, 1106 may be performed by application processor 1306, cellular baseband processor 1324, transceiver(s) 1322, antenna(s) 1380, CU processor 1412, DU processor 1432, RU processor 1442, transceiver(s) 1446, antenna(s) 1480, and/or BLCS component 198 of FIGS. 13 and 14. For example, referring to FIG. 8, the Tx device 802 may transmit QAM signal 816.

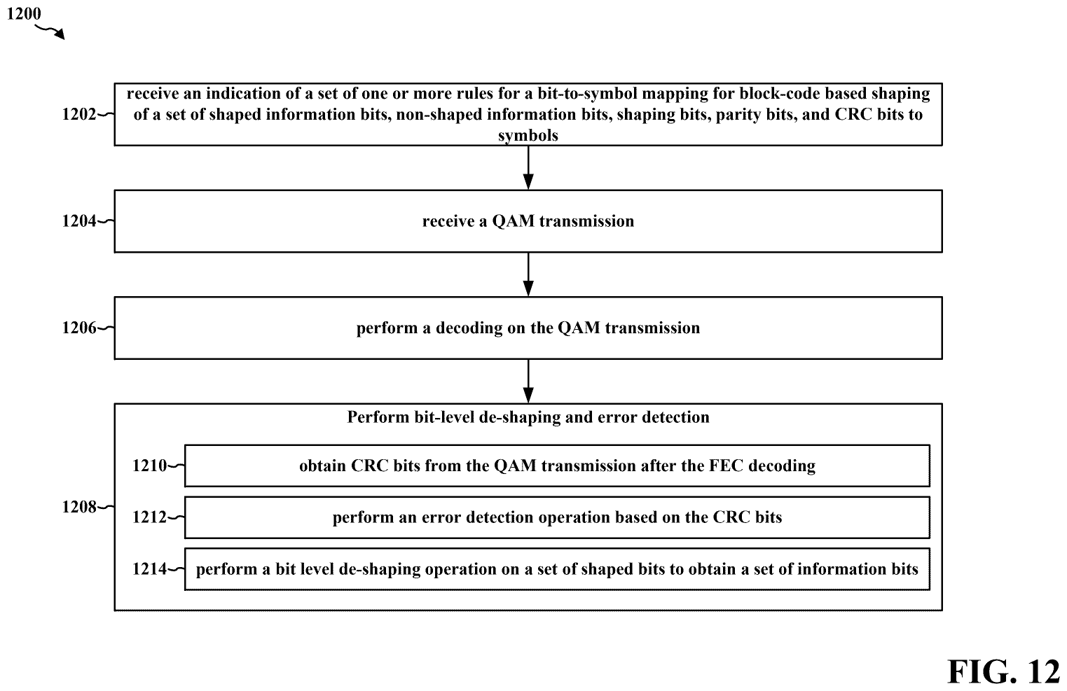

FIG. 12 is a flowchart 1200 of a method of wireless communication. The method may be performed by a receiving device such as a UE (e.g., the UE 104; the Rx device 804; the apparatus 1304) or a network node (e.g., the base station 102; the Rx device 804; the network entity 1402). At 1202, the Rx device may receive an indication of a set of one or more rules for a bit-to-symbol mapping for block-code based shaping of a set of shaped information bits, non-shaped information bits, shaping bits, parity bits, and CRC bits to symbols. For example, 1202 may be performed by application processor 1306, cellular baseband processor 1324, transceiver(s) 1322, antenna(s) 1380, CU processor 1412, DU processor 1432, RU processor 1442, transceiver(s) 1446, antenna(s) 1480, and/or BLCS component 198 of FIGS. 13 and 14. The mapping may include a first mapping that maps a first set of non-shaped information bits to a set of sign bits, a second set of shaped information bits to a set of MSBs, a third set of non-shaped information bits to a set of LSBs, a fourth set of shaping bits to a next set of LSBs, and a fifth set of parity (or CRC) bits to a last set of LSBs. The mapping, in some aspects, may include a second mapping that may map a first set of shaping bits to a set of sign bits, a second set of first parity bits to a remaining set of sign bits, a third set of shaped information bits to a set of MSBs, a fourth set of non-shaped information bits to a set of LSBs, and a fifth set of parity (or CRC) bits to a last set of LSBs.

The mapping, in some aspects, may include a third mapping that may map a first set of shaping bits to a set of sign bits, a second set of non-shaped information bits to a remaining set of sign bits, a third set of shaped information bits to a set of MSBs, a fourth set of non-shaped information bits to a set of LSBs, a fifth set of CRC bits to a next set of LSBs, and a sixth set of parity bits to a last set of LSBs. The mapping, in some aspects, may include a fourth mapping that may map a first set of shaping bits to a set of sign bits, a second set of CRC bits to a next set of sign bits, a third set of non-shaped information bits to a remaining set of sign bits, a fourth set of shaped information bits to a set of MSBs, a fifth set of non-shaped information bits to a set of LSBs, and a sixth set of CRC bits to a last set of LSBs. Additional configurations using MSBs for shaped information bits and other bits (e.g., sign bits and/or LSBs) for non-shaped information bits, shaping bits, parity bits, and/or CRC bits may be indicated in some aspects. The indication, in some aspects, may also indicate a set of conditions for utilizing each of a plurality of indicated mappings. For example, referring to FIG. 8, the Rx device 804 may receive mapping rules 806, indicating a mapping of a set of shaped information bits, non-shaped information bits, shaping bits, parity bits, and/or CRC bits to symbols based on one or more bit-to-symbol mappings for block-code based shaping in an order based on one or more rules.

At 1204, the Rx device may receive a QAM (or other amplitude modulated) transmission. For example, 1204 may be performed by application processor 1306, cellular baseband processor 1324, transceiver(s) 1322, antenna(s) 1380, CU processor 1412, DU processor 1432, RU processor 1442, transceiver(s) 1446, antenna(s) 1480, and/or BLCS component 198 of FIGS. 13 and 14. Referring to FIG. 8, for example, the Rx device 804 may receive QAM signal 816.

At 1206, the Rx device may perform a decoding of the QAM transmission. For example, 1206 may be performed by application processor 1306, cellular baseband processor 1324, CU processor 1412, DU processor 1432, RU processor 1442, and/or BLCS component 198 of FIGS. 13 and 14. The decoding may be a FEC decoding used to reproduce a set of soft bits associated with a set of shaped bits, shaping bits, and non-shaped bits. For example, referring to FIGS. 5-8, the Rx device 804 may perform FEC decoding at 820 a set of shaped information bits, non-shaped information bits, shaping bits, parity bits, and/or CRC bits from the QAM signal 816 according to a mapping of any of diagram 700-730.

At 1208, the Rx device may perform a bit-level de-shaping and error detection. The bit-level de-shaping and error detection may include obtaining, at 1210, CRC bits from the QAM transmission after the FEC decoding, performing, at 1212, a error detection operation based on the CRC bits, and performing, at 1214, a bit level de-shaping operation on a set of shaped bits to obtain a set of information bits. For example, 1208-1214 may be performed by application processor 1306, cellular baseband processor 1324, CU processor 1412, DU processor 1432, RU processor 1442, and/or BLCS component 198 of FIGS. 13 and 14. The CRC bits may be obtained at 1210, and the error detection may be performed at 1212) before or after the bit level de-shaping at 1214 based on whether the CRC was added to the information bits before or after a shaping operation. In some aspects, a CRC may be added after a bit-shaping operation in order to allow the RX device to perform an error detection operation immediately after the FEC decoding instead of after a bit level de-shaping to recover the CRC bits to be used for the error detection operation. However, adding the CRC after a bit-shaping operation may lead to CRC bits being placed at bits with higher reliability thus degrading performance compared to adding the CRC bits before the bit level shaping operation. For example, referring to FIGS. 5-8, the RX device 804 may obtain the CRC bits at 822 and perform a bit-level de-shaping operation at 824 based on one of the encoding pipelines illustrated in diagrams 500 or 600 and one of the mappings 700-730.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the BLCS component 198 is configured to process input information including a set of information bits for a QAM transmission by performing a bit-shaping operation for the set of information bits to generate a set of shaped bits and adding CRC bits before FEC on a combination of the set of information bits and the CRC bits; and transmit the QAM transmission. In certain aspects, the BLCS component 198 may be configured to receive a QAM transmission; perform a FEC decoding on the QAM transmission; obtain CRC bits from the QAM transmission after the FEC decoding; and perform a bit level de-shaping operation on a set of shaped bits to obtain a set of information bits. In certain aspects, the BLCS component 198 may be configured to perform a bit-shaping operation for a set of information bits to generate a set of shaped information bits; map the set of shaped information bits, non-shaped information bits, shaping bits, parity bits, and CRC bits to symbols with a bit-to-symbol mapping for block-code based shaping in an order based on one or more rules; and transmitting a QAM transmission. In certain aspects, the BLCS component 198 may be configured to receive an indication of a set of one or more rules for a bit-to-symbol mapping for block-code based shaping of a set of shaped information bits, non-shaped information bits, shaping bits, parity bits, and CRC bits to symbols; receive a QAM transmission; perform a decoding on the QAM transmission; and perform a bit level de-shaping operation on a set of shaped bits included in the QAM transmission to obtain a set of information bits based on the indication of the one or more rules. The BLCS component 198 may be within the cellular baseband processor 1324, the application processor 1306, or both the cellular baseband processor 1324 and the application processor 1306. The BLCS component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for processing input information comprising a set of information bits for a QAM transmission. The apparatus 1304, and in particular the cellular baseband processor 1324 and/or the application processor 1306, may also include means for performing a bit-shaping operation for the set of information bits to generate a set of shaped bits. The apparatus 1304, and in particular the cellular baseband processor 1324 and/or the application processor 1306, may also include means for adding CRC bits before FEC on a combination of the set of information bits and the CRC bits. The apparatus 1304, and in particular the cellular baseband processor 1324 and/or the application processor 1306, may also include means for transmitting the QAM transmission. The apparatus 1304, and in particular the cellular baseband processor 1324 and/or the application processor 1306, may also include means for receiving a QAM transmission. The apparatus 1304, and in particular the cellular baseband processor 1324 and/or the application processor 1306, may also include means for performing a FEC decoding on the QAM transmission. The apparatus 1304, and in particular the cellular baseband processor 1324 and/or the application processor 1306, may also include means for obtaining CRC bits from the QAM transmission after the FEC decoding. The apparatus 1304, and in particular the cellular baseband processor 1324 and/or the application processor 1306, may also include means for performing a bit level de-shaping operation on a set of shaped bits to obtain a set of information bits. The apparatus 1304, and in particular the cellular baseband processor 1324 and/or the application processor 1306, may also include means for performing a bit-shaping operation for a set of information bits to generate a set of shaped information bits. The apparatus 1304, and in particular the cellular baseband processor 1324 and/or the application processor 1306, may also include means for mapping the set of shaped information bits, non-shaped information bits, shaping bits, and parity bits to symbols based on a bit-to-symbol mapping for block-code based shaping in an order based on one or more rules. The apparatus 1304, and in particular the cellular baseband processor 1324 and/or the application processor 1306, may also include means for transmitting a QAM transmission. The apparatus 1304, and in particular the cellular baseband processor 1324 and/or the application processor 1306, may also include means for receiving an indication of a set of one or more rules for a bit-to-symbol mapping for block-code based shaping of a set of shaped information bits, non-shaped information bits, shaping bits, parity bits, and CRC bits to symbols. The apparatus 1304, and in particular the cellular baseband processor 1324 and/or the application processor 1306, may also include means for receiving a QAM transmission. The apparatus 1304, and in particular the cellular baseband processor 1324 and/or the application processor 1306, may also include means for performing a decoding on the QAM transmission. The apparatus 1304, and in particular the cellular baseband processor 1324 and/or the application processor 1306, may also include means for performing a bit level de-shaping operation on a set of shaped bits included in the QAM transmission to obtain a set of information bits based on the indication of the one or more rules. The apparatus may include means for performing any of the aspects described in connection with the flowcharts in FIGS. 9-12 and/or the aspects performed by either the Tx or Rx device in FIG. 8. The means may be the BLCS component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the BLCS component 198, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an Fl interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the BLCS component 198 is configured to process input information including a set of information bits for a QAM transmission by performing a bit-shaping operation for the set of information bits to generate a set of shaped bits and adding CRC bits before FEC on a combination of the set of information bits and the CRC bits; and transmit the QAM transmission. In certain aspects, the BLCS component 198 may be configured to receive a QAM transmission; perform a FEC decoding on the QAM transmission; obtain CRC bits from the QAM transmission after the FEC decoding; and perform a bit level de-shaping operation on a set of shaped bits to obtain a set of information bits. In certain aspects, the BLCS component 198 may be configured to perform a bit-shaping operation for a set of information bits to generate a set of shaped information bits; map the set of shaped information bits, non-shaped information bits, shaping bits, parity bits, and CRC bits to symbols with a bit-to-symbol mapping for block-code based shaping in an order based on one or more rules; and transmitting a QAM transmission. In certain aspects, the BLCS component 198 may be configured to receive an indication of a set of one or more rules for a bit-to-symbol mapping for block-code based shaping of a set of shaped information bits, non-shaped information bits, shaping bits, parity bits, and CRC bits to symbols; receive a QAM transmission; perform a decoding on the QAM transmission; and perform a bit level de-shaping operation on a set of shaped bits included in the QAM transmission to obtain a set of information bits based on the indication of the one or more rules. The BLCS component 198 may be within one or more processors of one or more of the CU 1410, DU 1430, and the RU 1440. The BLCS component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for means for processing input information comprising a set of information bits for a QAM transmission. The apparatus the network entity 1302, and in particular the cellular baseband processor 1324 and/or the application processor 1306, may also include means for performing a bit-shaping operation for the set of information bits to generate a set of shaped bits. The network entity 1402 may also include means for adding CRC bits before FEC on a combination of the set of information bits and the CRC bits. The network entity 1402 may also include means for transmitting the QAM transmission. The network entity 1402 may also include means for receiving a QAM transmission. The network entity 1402 may also include means for performing a FEC decoding on the QAM transmission. The network entity 1402 may also include means for obtaining CRC bits from the QAM transmission after the FEC decoding. The network entity 1402 may also include means for performing a bit level de-shaping operation on a set of shaped bits to obtain a set of information bits. The network entity 1402 may also include means for performing a bit-shaping operation for a set of information bits to generate a set of shaped information bits. The network entity 1402 may also include means for mapping the set of shaped information bits, non-shaped information bits, shaping bits, and parity bits to symbols based on a bit-to-symbol mapping for block-code based shaping in an order based on one or more rules. The network entity 1402 may also include means for transmitting a QAM transmission. The network entity 1402 may also include means for receiving an indication of a set of one or more rules for a bit-to-symbol mapping for block-code based shaping of a set of shaped information bits, non-shaped information bits, shaping bits, parity bits, and CRC bits to symbols. The network entity 1402 may also include means for receiving a QAM transmission. The network entity 1402 may also include means for performing a decoding on the QAM transmission. The network entity 1402 may also include means for performing a bit level de-shaping operation on a set of shaped bits included in the QAM transmission to obtain a set of information bits based on the indication of the one or more rules. The apparatus may include means for performing any of the aspects described in connection with the flowcharts in FIGS. 9-12 and/or the aspects performed by either the Tx or Rx device in FIG. 8. The means may be the BLCS component 198 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

In a shaping process, the probability of ‘u₀’ and/or ‘u₁’ taking a value of ‘0’ may be increased compared to probability of ‘u₀’ and/or ‘u₁’ taking a value of ‘1’ so that the average power is reduced. In some aspects of shaping encoders, a transmitter may ‘mask’ information bits and then jointly encode the shaped information bits and information for shaping. A corresponding decoder may jointly decode shaped information bits and the information for shaping and then reencode the bits to recover the original information bits. For some implementations, bit-level shaping is performed by mapping parity bits to high reliability bits (e.g., sign bits) while the shaped bits may be mapped to the remaining bit locations (e.g., MSBs and/or LSBs, excluding sign bits). In some aspects of the disclosure a mapping of shaped information bits, non-shaped information bits, shaping bits, parity, and/or CRC bits is provided to reduce an average transmission power.*

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication including processing input information including a set of information bits for a QAM transmission by (1) performing a bit-shaping operation for the set of information bits to generate a set of shaped bits and (2) adding CRC bits before FEC on a combination of the set of information bits and the CRC bits; and transmitting the QAM transmission.

Aspect 2 is the method of aspect 1, where the CRC bits are added to the set of information bits before performing the bit-shaping operation for the set of information bits.

Aspect 3 is the method of any of aspects 1 and 2, where the CRC bits are added to the set of information bits after performing the bit-shaping operation for the set of information bits.

Aspect 4 is the method of any of aspects 1 to 3, further including mapping the set of shaped information bits, non-shaped information bits, shaping bits, and parity bits to symbols based on a bit-to-symbol mapping for block-code based shaping in an order based on one or more rules.

Aspect 5 is the method of aspect 4, where the bit-to-symbol mapping includes mapping the non-shaped information bits to a set of sign bits and the set of shaped information bits to a set of MSBs and mapping remaining non-shaped information bits and shaping bits and the parity bits to a set of remaining bits.

Aspect 6 is the method of aspect 4, where the bit-to-symbol mapping includes mapping the shaping bits and a first set of bits of the parity bits to a set of sign bits, mapping the set of shaped information bits to a set of MSBs, and mapping a second set of bits of the parity bits to a set of LSBs.

Aspect 7 is the method of aspect 6, where the bit-to-symbol mapping further includes mapping the non-shaped information bits to a set of bits between the MSBs to which the set of shaped information bits is mapped and the LSBs to which the second set of bits of the parity bits is mapped.

Aspect 8 is a method of wireless communication including receiving a QAM transmission; performing a FEC decoding on the QAM transmission; obtaining CRC bits from the QAM transmission after the FEC decoding; and performing a bit level de-shaping operation on a set of shaped bits to obtain a set of information bits.

Aspect 9 is the method of aspect 8, where the CRC bits are obtained and CRC check are performed after the bit level de-shaping operation.

Aspect 10 is the method of aspect 8, where the CRC bits are obtained and CRC check are performed before the bit level de-shaping operation.

Aspect 11 is the method of any of aspects 8 to 10, further including de-mapping a set of symbols into the set of shaped information bits, non-shaped information bits, shaping bits, and parity bits based on a bit-to-symbol mapping for block-code based shaping in an order based on one or more rules.

Aspect 12 is the method of aspect 11, where the bit-to-symbol mapping includes a mapping of the non-shaped information bits to a set of sign bits and the set of shaped information bits to a set of MSBs and a mapping of remaining non-shaped information bits, shaping bits and the parity bits to a set of remaining bits.

Aspect 13 is the method of aspect 11, where the bit-to-symbol mapping includes a mapping of the shaping bits and a first set of bits of the parity bits to a set of sign bits, a mapping of the set of shaped information bits to a set of MSBs, and a mapping of a second set of bits of the parity bits to a set of LSBs.

Aspect 14 is the method of aspect 11, where the bit-to-symbol mapping further includes a mapping of the non-shaped information bits to a set of bits between the MSBs to which the set of shaped information bits is mapped and the LSBs to which the second set of bits of the parity bits is mapped.

Aspect 15 is a method of wireless communication including performing a bit-shaping operation for a set of information bits to generate a set of shaped information bits; mapping the set of shaped information bits, non-shaped information bits, shaping bits, and parity bits to symbols based on a bit-to-symbol mapping for block-code based shaping in an order based on one or more rules; and transmitting a QAM transmission.

Aspect 16 is the method of aspect 15, where the bit-to-symbol mapping includes mapping the non-shaped information bits to a set of sign bits and the set of shaped information bits to a set of MSBs and mapping remaining non-shaped information bits and shaping bits and the parity bits to a set of remaining bits.

Aspect 17 is the method of aspect 15, where the bit-to-symbol mapping includes mapping the shaping bits and a first set of bits of the parity bits to a set of sign bits, mapping the set of shaped information bits to a set of MSBs, and mapping a second set of bits of the parity bits to a set of LSBs.

Aspect 18 is the method of aspect 17, where the bit-to-symbol mapping further includes mapping the non-shaped information bits to a set of bits between the MSBs to which the set of shaped information bits is mapped and the LSBs to which the second set of bits of the parity bits is mapped.

Aspect 19 is the method of any of aspects 15-18, where CRC bits are added to the set of information bits before performing the bit-shaping operation for the set of information bits and performing the bit-shaping operation includes performing the bit-shaping operation for the set of information bits and the CRC bits to generate the set of shaped information bits.

Aspect 20 is the method of any of aspects 15-18, where the bit-to-symbol mapping further includes mapping CRC bits to symbols based on the bit-to-symbol mapping for block-code based shaping in the order based on the one or more rules.

Aspect 21 is a method of wireless communication including receiving an indication of a set of one or more rules for a bit-to-symbol mapping for block-code based shaping of a set of shaped information bits, non-shaped information bits, shaping bits, parity bits, and CRC bits to symbols; receiving a QAM transmission; performing a decoding on the QAM transmission; and performing a bit level de-shaping operation on a set of shaped bits included in the QAM transmission to obtain a set of information bits based on the indication of the one or more rules.

Aspect 22 is the method of aspect 21, further including obtaining CRC bits for error detection after the bit level de-shaping operation; and performing an error detection operation based on the CRC bits.

Aspect 23 is the method of aspect 21, further including obtaining CRC bits for error detection before the bit level de-shaping operation; and performing an error detection operation based on the CRC bits before performing the bit level de-shaping operation.

Aspect 24 is the method of any of aspects 21-23, where the bit-to-symbol mapping includes a mapping of the non-shaped information bits to a set of sign bits and the set of shaped information bits to a set of MSBs and a mapping of remaining non-shaped information bits, shaping bits and the parity bits to a set of remaining bits.

Aspect 25 is the method of aspect 21-23, where the bit-to-symbol mapping includes a mapping of the shaping bits and a first set of bits of the parity bits to a set of sign bits, a mapping of the set of shaped information bits to a set of MSBs, and a mapping of a second set of bits of the parity bits to a set of LSBs.

Aspect 26 is the method of aspect 25, where the bit-to-symbol mapping further includes a mapping of the non-shaped information bits to a set of bits between the MSBs to which the set of shaped information bits is mapped and the LSBs to which the second set of bits of the parity bits is mapped.

Aspect 27 is an apparatus for wireless communication at a device including a memory and at least one processor coupled to the memory and, based at least in part on information stored in the memory, the at least one processor is configured to implement any of aspects 1 to 26.

Aspect 28 is the apparatus of aspect 27, further including a transceiver or an antenna coupled to the at least one processor.

Aspect 29 is an apparatus for wireless communication at a device including means for implementing any of aspects 1 to 26.

Aspect 30 is a computer-readable medium (e.g., a non-transitory computer-readable medium) storing computer executable code, where the code when executed by a processor causes the processor to implement any of aspects 1 to 26.

What is claimed is:

1. An apparatus for wireless communication, comprising:
a memory; and
at least one processor coupled to the memory and, based at least in part on information stored in the memory, the at least one processor is configured to:
process input information comprising a set of information bits for a quadrature amplitude modulated (QAM) transmission by:
perform a bit-shaping operation for the set of information bits to generate a set of shaped bits; and
add cyclic redundancy check (CRC) bits before forward error correction (FEC) on a combination of the set of information bits and the CRC bits; and
transmit the QAM transmission.

2. The apparatus of claim 1, wherein the CRC bits are added to the set of information bits before performing the bit-shaping operation for the set of information bits.

3. The apparatus of claim 1, wherein the CRC bits are added to the set of information bits after performing the bit-shaping operation for the set of information bits.

4. The apparatus of claim 1, wherein the at least one processor is further configured to:
map the set of shaped information bits, non-shaped information bits, shaping bits, and parity bits to symbols based on a bit-to-symbol mapping for block-code based shaping in an order based on one or more rules.

5. The apparatus of claim 4, wherein the bit-to-symbol mapping comprises mapping the non-shaped information bits to a set of sign bits and the set of shaped information bits to a set of most significant bits (MSBs) and mapping remaining non-shaped information bits and shaping bits and the parity bits to a set of remaining bits.

6. The apparatus of claim 4, wherein the bit-to-symbol mapping comprises mapping the shaping bits and a first set of bits of the parity bits to a set of sign bits, mapping the set of shaped information bits to a set of most significant bits (MSBs), and mapping a second set of bits of the parity bits to a set of least significant bits (LSBs).

7. The apparatus of claim 6, wherein the bit-to-symbol mapping further comprises mapping the non-shaped information bits to a set of bits between the MSBs to which the set of shaped information bits is mapped and the LSBs to which the second set of bits of the parity bits is mapped.

8. The apparatus of claim 1, further comprising a transceiver or an antenna coupled to the at least one processor, wherein the at least one processor is configured to transmit the QAM transmission via the transceiver or the antenna.

9. An apparatus for wireless communication, comprising:
a memory; and
at least one processor coupled to the memory and, based at least in part on information stored in the memory, the at least one processor is configured to:
receive a quadrature amplitude modulated (QAM) transmission;
perform a forward error correction (FEC) decoding on the QAM transmission;
obtain cyclic redundancy check (CRC) bits from the QAM transmission after the FEC decoding; and
perform a bit level de-shaping operation on a set of shaped bits to obtain a set of information bits.

10. The apparatus of claim 9, wherein the CRC bits are obtained and CRC check are performed after the bit level de-shaping operation.

11. The apparatus of claim 9, wherein the CRC bits are obtained and CRC check are performed before the bit level de-shaping operation.

12. The apparatus of claim 9, wherein the at least one processor is further configured to:
de-map a set of symbols into the set of shaped information bits, non-shaped information bits, shaping bits, and parity bits based on a bit-to-symbol mapping for block-code based shaping in an order based on one or more rules.

13. The apparatus of claim 12, wherein the bit-to-symbol mapping comprises a mapping of the non-shaped information bits to a set of sign bits and the set of shaped information bits to a set of most significant bits (MSBs) and a mapping of remaining non-shaped information bits, shaping bits and the parity bits to a set of remaining bits.

14. The apparatus of claim 12, wherein the bit-to-symbol mapping comprises a mapping of the shaping bits and a first set of bits of the parity bits to a set of sign bits, a mapping of the set of shaped information bits to a set of most significant bits (MSBs), and a mapping of a second set of bits of the parity bits to a set of least significant bits (LSBs).

15. The apparatus of claim 14, wherein the bit-to-symbol mapping further comprises a mapping of the non-shaped information bits to a set of bits between the MSBs to which the set of shaped information bits is mapped and the LSBs to which the second set of bits of the parity bits is mapped.

16. The apparatus of claim 9, further comprising a transceiver or an antenna coupled to the at least one processor, wherein the at least one processor is configured to receive the QAM transmission via the transceiver or the antenna.

17. An apparatus for wireless communication, comprising:
a memory; and
at least one processor coupled to the memory and, based at least in part on information stored in the memory, the at least one processor is configured to:
perform a bit-shaping operation for a set of information bits to generate a set of shaped information bits;
map the set of shaped information bits, non-shaped information bits, shaping bits, and parity bits to symbols based on a bit-to-symbol mapping for block-code based shaping in an order based on one or more rules; and
transmit a quadrature amplitude modulated (QAM) transmission.

18. The apparatus of claim 17, wherein the bit-to-symbol mapping comprises mapping the non-shaped information bits to a set of sign bits and the set of shaped information bits to a set of most significant bits (MSBs) and mapping remaining non-shaped information bits and shaping bits and the parity bits to a set of remaining bits.

19. The apparatus of claim 17, wherein the bit-to-symbol mapping comprises mapping the shaping bits and a first set of bits of the parity bits to a set of sign bits, mapping the set of shaped information bits to a set of most significant bits (MSBs), and mapping a second set of bits of the parity bits to a set of least significant bits (LSBs).

20. The apparatus of claim 19, wherein the bit-to-symbol mapping further comprises mapping the non-shaped information bits to a set of bits between the MSBs to which the set of shaped information bits is mapped and the LSBs to which the second set of bits of the parity bits is mapped.

21. The apparatus of claim 17, wherein cyclic redundancy check (CRC) bits are added to the set of information bits before performing the bit-shaping operation for the set of information bits and performing the bit-shaping operation comprises performing the bit-shaping operation for the set of information bits and the CRC bits to generate the set of shaped information bits.

22. The apparatus of claim 17, wherein the bit-to-symbol mapping further comprises mapping cyclic redundancy check (CRC) bits to symbols based on the bit-to-symbol mapping for block-code based shaping in the order based on the one or more rules.

23. The apparatus of claim 17, further comprising a transceiver or an antenna coupled to the at least one processor, wherein the at least one processor is configured to transmit the QAM transmission via the transceiver or the antenna.

24. An apparatus for wireless communication, comprising:
a memory; and
at least one processor coupled to the memory and, based at least in part on information stored in the memory, the at least one processor is configured to:
receive an indication of a set of one or more rules for a bit-to-symbol mapping for block-code based shaping of a set of shaped information bits, non-shaped information bits, shaping bits, parity bits, and cyclic redundancy check (CRC) bits to symbols;
receive a quadrature amplitude modulated (QAM) transmission;
perform a decoding on the QAM transmission; and
perform a bit level de-shaping operation on a set of shaped bits included in the QAM transmission to obtain a set of information bits based on the indication of the one or more rules.

25. The apparatus of claim 24, wherein the at least one processor is further configured to:
obtaining CRC bits for error detection after the bit level de-shaping operation; and
performing an error detection operation based on the CRC bits.

26. The apparatus of claim 24, wherein the at least one processor is further configured to:
obtaining CRC bits for error detection before the bit level de-shaping operation; and
performing an error detection operation based on the CRC bits before performing the bit level de-shaping operation.

27. The apparatus of claim 24, wherein the bit-to-symbol mapping comprises a mapping of the non-shaped information bits to a set of sign bits and the set of shaped information bits to a set of most significant bits (MSBs) and a mapping of remaining non-shaped information bits, shaping bits and the parity bits to a set of remaining bits.

28. The apparatus of claim 24, wherein the bit-to-symbol mapping comprises a mapping of the shaping bits and a first set of bits of the parity bits to a set of sign bits, a mapping of the set of shaped information bits to a set of most significant bits (MSBs), and a mapping of a second set of bits of the parity bits to a set of least significant bits (LSBs).

29. The apparatus of claim 28, wherein the bit-to-symbol mapping further comprises a mapping of the non-shaped information bits to a set of bits between the MSBs to which the set of shaped information bits is mapped and the LSBs to which the second set of bits of the parity bits is mapped.

30. The apparatus of claim 24, further comprising a transceiver or an antenna coupled to the at least one processor, wherein the at least one processor is configured to receive the QAM transmission via the transceiver or the antenna.
